(19) United States
(12) Patent Application Publication
(10) Pub. No.: US 2007/0209896 A1
(43) Pub. Date: Sep. 13, 2007

(54) Rotational coupling device

(76) Inventor: James A. Pardee, Glen Ellyn, IL (US)

Correspondence Address: DYKEMA GOSSETT PLLC, 39577 WOODWARD AVENUE, SUITE 300, BLOOMFIELD HILLS, MI, 48304-5086, US

(21) Appl. No.: 11/372,693

(22) Filed: Mar. 10, 2006

(51) Int. Cl. F16D 67/06

(52) U.S. Cl. 192/18 B

(57) ABSTRACT

A rotational coupling device for use as a clutch and/or brake is provided having a modular construction enabling relatively easy variation of braking torque and having improved magnetic efficiency during brake engagement and release. The device includes one or more brake modules attached to a mounting bracket to vary braking torque. The brake modules include brake poles axially aligned with one portion of an armature. Permanent magnets are contained in one of the brake pole and the armature and axially aligned with the other providing a strong magnetic circuit. The mounting bracket is axially aligned with another portion of the armature, radially outward of the portion aligned with the brake pole. At least one of the mounting bracket and the aligned portion of the armature has a high magnetic reluctance providing a flux busting gap in the magnetic circuit that allows easier release of the brake.

### BACKGROUND OF THE INVENTION

1. Field of the Invention

This invention relates to rotational coupling devices such as brakes and clutches and, in particular, to a rotational coupling device having a modular construction enabling relatively easy variation of braking torque and having improved magnetic efficiency in the application and removal of braking torque during operation of the device.

2. Discussion of Related Art

Rotational coupling devices such as clutches and brakes are used to control transfer of torque between rotational bodies. One type of conventional device is illustrated in U.S. Pat. Nos. 5,119,918, 5,285,882 and 5,971,121, the entire disclosures of which are incorporated herein by reference. This device includes a rotor that is coupled to an input shaft for rotation with the input shaft about a rotational axis. A field shell is also disposed about the input shaft on one side of the rotor and is fixed against rotation. The field shell defines radially spaced, axially extending inner and outer poles between which an electrical conductor is disposed, facing the rotor. A brake pole is coupled to the field shell and axially spaced from the field shell. The brake pole is disposed on a side of the rotor opposite the conductor. An armature coupled to an output member is disposed on the same side of the rotor as the brake pole and is disposed axially between the rotor and the brake pole. The armature is coupled to an output member by a plurality of leaf springs. Energizing the conductor produces a magnetic circuit in the field shell, rotor and armature that draws the armature into engagement with the rotor and couples the input shaft and output member together for rotation. Upon deenergization of the conductor, the leaf springs draw the armature out of engagement with the rotor and into engagement with the brake pole to brake the armature and output member. Permanent magnets coupled to the brake pole are also used to create another magnetic circuit between the brake pole, the field shell and the armature to assist the leaf springs in braking the armature and output member.

The above described devices generally perform well. At least some of the devices, however, are not easily scalable to adjust for varying brake torque requirements. The magnetic circuits within the device are also not optimally efficient nor isolated from each other. Further, the armature is difficult to disengage from the brake pole and the clutch engagement surfaces of the device still suffer from an undesirable amount of wear.

The inventors herein have recognized a need for a rotational coupling device that will minimize and/or eliminate one or more of the above-identified deficiencies.

### SUMMARY OF THE INVENTION

The present invention provides a rotational coupling device.

A rotational coupling device in accordance with the present invention includes a rotor coupled to an input shaft for rotation therewith. The input shaft is disposed about a rotational axis. The device also includes a field shell disposed about the input shaft and fixed against rotation and an electrical conductor disposed within the field shell on a first side of the rotor. The device further includes an armature disposed about the axis on a second side of the rotor opposite the conductor. The armature is coupled to an output member. The device further includes a mounting bracket coupled to the field shell and a brake pole coupled to the mounting bracket The brake pole defines a braking surface axially aligned with a first portion of the armature on a side of the armature opposite the rotor. A permanent magnet is coupled to one of the brake pole and the armature and axially aligned with the other of the brake pole and the armature. In accordance with one embodiment of the present invention, the mounting bracket is axially aligned with a second portion of the armature. The second portion of the armature is disposed radially outward of the first portion of the armature and at least one of the mounting bracket and the second portion of the armature has a magnetic reluctance greater than a magnetic reluctance of the brake pole and the first portion of the armature.

A rotational coupling device in accordance with the present invention represents an improvement over conventional devices. The use of a mounting bracket to mount the brake pole enables the use of varying numbers of brake modules that allow easy variation of the device for varying brake torque requirements. The mounting bracket also serves to isolate the magnetic circuit created by the armature, magnet, and brake pole (i.e., the braking circuit) from the magnetic circuit created by the armature, rotor and field shell upon energization of the conductor (i.e., the clutch circuit). In particular, by forming the mounting bracket or a portion of the armature of a material having a higher magnetic reluctance than the brake pole and the rest of the armature and aligning the two radially outward of the brake pole/armature interface, the magnetic circuits are isolated from one another. Further, brake release and clutch engagement is rendered more efficient because the portion of the armature engaging the mounting bracket is the last part of the armature to disengage and the inventive structure therefore breaks the magnetic circuit for the brake more quickly.

These and other advantages of this invention will become apparent to one skilled in the art from the following detailed description and the accompanying drawings illustrating features of this invention by way of example.

### BRIEF DESCRIPTION OF THE DRAWINGS

FIGS. 1 is a plan view of a rotational coupling device in accordance with one embodiment of the present invention.

FIG. 2 is a cross-sectional view of the rotational coupling device of FIG. 1.

FIG. 3 is an enlarged cross-sectional view of a portion of the rotational coupling device of FIGS. 1-2.

FIG. 4 is a plan view of a rotational coupling device in accordance with one embodiment of the present invention.

FIG. 5 is an enlarged cross-sectional view of a portion of a rotational coupling device in accordance with another embodiment of the present invention.

FIG. 6 is an enlarged cross-sectional view of a portion of a rotational coupling device of FIGS. 1-2 illustrating an operational position of the device.

FIG. 7 is an enlarged cross-sectional view of a portion of a rotational coupling device in accordance with another embodiment of the present invention.

### DETAILED DESCRIPTION OF EMBODIMENTS OF THE INVENTION

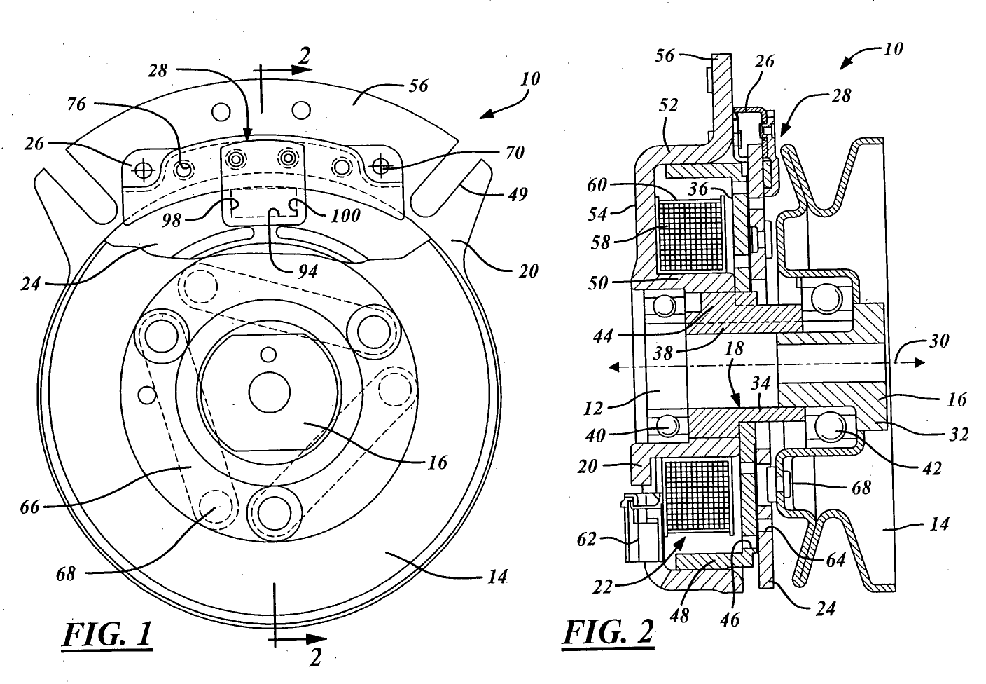

Referring now to the drawings wherein like reference numerals are used to identify identical components in the various views, FIGS. 1-2 illustrates a rotational coupling device 10 in accordance with one embodiment of the present invention. Device 10 functions as a clutch to selectively transfer torque from an input shaft 12 to an output member 14. Device 10 also functions as a brake on output member 14 when torque is not being transferred to output member 14. Device 10 may be provided for use in a riding lawnmower or similar device. It will be understood by those of ordinary skill in the art, however, that device 10 may be used in a wide variety of applications requiring a clutch or brake. Device 10 may include a spacer 16, a rotor 18, a field shell 20, an electrical conduction assembly 22, an armature 24, a mounting bracket 26, and one or more brake modules 28.

Input shaft 12 provides a source of torque for driving output member 14. Shaft 12 may be made from conventional metals and metal alloys and may be solid or tubular. Shaft 12 is centered about a rotational axis 30 and is driven by an engine, electric motor or other conventional power source. In the illustrated embodiment input shaft 12 is inserted into device 10 on a side of device 10 opposite output member 14. It should be understood, however, that the orientation of input shaft 12 and spacer 16 could be reversed such that input shaft 12 is inserted into device 10 on the same side as output member 14.

Output member 14 transfers torque to a driven device such as a lawnmower blade. Member 14 may comprise a conventional pulley around which a torque transmitting belt is wound and coupled to the driven device.

Spacer 16 is provided to support output member 14 in assembled relation with the other components of device 10 and may be made from conventional materials including powdered metals. Spacer 16 is disposed about axis 30 and is generally cylindrical in shape. Spacer 16 has a generally cylindrical outer surface that may include a keyway configured to receive a key of rotor 18. Spacer 16 also defines a flange 32 at one axial end.

Rotor 18 is provided for selective engagement with armature 24 to transmit torque between input shaft 12 and output member 14. Rotor 18 is disposed about axis 30 and is coupled to input shaft 12 for rotation therewith. Rotor 18 may be made from conventional metals and metal alloys and includes a hub 34 and a rotor disc 36.

Hub 34 is tubular and includes a radially inwardly extending key 38 configured to be received within the keyways of input shaft 12 and spacer 16. At either axial end, hub 34 abuts against bearings 40, 42. At its radially outer diameter, hub 34 defines an axially extending inner rotor pole 44.

Disc 36 extends radially outwardly from hub 34. Disc 36 is coupled to hub 34 through, for example, a press-fit relationship including plurality of complementary lugs and notches. As is known in the art, disc 36 may include a plurality of radially spaced rows of angularly spaced, banana shaped slots 46. Upon energization of conduction assembly 22, slots 46 cause magnetic flux to travel back an forth between disc 36 and armature 24 across an air gap enabling a high torque engagement between rotor 18 and armature 24. In the illustrated embodiment, disc 36 includes two rows of slots 46. It should be understood, however, that the number of rows of slots 46, the number of slots 46 in any one row, and the size and shape of slots 46 may vary. At its outer diameter, disc 36 defines an axially extending outer rotor pole 48. Pole 48 is radially aligned with pole 44 and spaced radially outwardly of pole 44.

Field shell 20 is provided to house conduction assembly 22. Shell 20 also forms part of a magnetic circuit that causes the selective engagement of rotor 18 and armature 24. Field shell 20 may be made from conventional metals and metal alloys, including steel. Shell 20 is cylindrical and is disposed about axis 30. Shell 20 is fixed against rotation through, for example, a fastener (not shown) extending through a slot 49 in shell 20. Shell 20 is supported on an outer race of bearing 40. Shell 20 is generally U-shaped in cross-section defining axially extending inner and outer poles 50, 52 and an end wall 54 extending radially between poles 50, 52. Poles 50, 52, are disposed radially outwardly of inner and outer rotor pole 44, 48, respectively. Shell 20 further defines an integral flange 56 that extends radially outwardly from pole 52 at an end of pole 52 opposite end wall 54. Referring to FIG. 1, flange 56 extends along at least a portion of the circumference of pole 52.

Conduction assembly 22 is provided to create a magnetic circuit among rotor 18, field shell 20, and armature 24 to cause movement of armature 24 into engagement with rotor 18 and transmission of torque from input shaft 12 to output member 14. Conduction assembly 22 is generally annular and is disposed about axis 30 within field shell 20. In particular, assembly 22 is disposed between the inner and outer poles 50, 52 of shell 20. Assembly 22 includes a conductor 58 and a shell 60.

Conductor 58 may comprise a conventional copper coil although other known conductors may alternatively be used. Conductor 58 may be connected electrically to a power supply (not shown) such as a battery. Upon energization of conductor 58, a magnetic circuit is formed between rotor 18, field shell 20, and armature 24. Magnetic flux flows from pole 52 of shell 20 across an air gap to pole 48 of rotor 18. Flux then travels back and forth between disc 36 and armature 24 across the air gap between them. Flux then flows from disc 36 to hub 34 of rotor 18 and back across an air gap to inner pole 50 and through wall 54 of field shell 20.

Shell 60 is provided to house conductor 58 and is also used to mount conductor 58 within field shell 20. Shell 60 may be molded from conventional plastics. Shell 60 may include an integral terminal connector 62 through which conductor 58 may be electrically connected to a power source. Shell 60 may also define one or more lugs (not shown) sized to be received within recesses in end wall 54 to prevent rotation of conduction assembly 22. Shell 60 may include a radially outwardly extending flange (not shown) disposed proximate outer pole 52 of field shell 20 and affixed to shell 20 at a plurality of points as described in commonly assigned pending U.S. patent application Ser. No. 11/150,670, the entire disclosure of which is incorporated herein by reference.

Armature 24 is provided to transmit a braking torque to output member 14 and to selectively transmit a drive torque from rotor 18 to output member 14. Armature 24 may be made from a variety of conventional metals and metal alloys including steel. Armature 24 is annular in construction and disposed about axis 30. Armature 24 is axially spaced from rotor 18 by an air gap. Like rotor disc 36, armature 24 includes a plurality of radially spaced rows of angularly spaced slots 64 that facilitate travel of magnetic flux back and forth between rotor 18 and armature 24 upon energization of conduction assembly 22. In the illustrated embodiment, armature 24 includes two rows of slots 64. It should be understood that the number of rows of slots 64 on armature 24, the number of slots 64 in any one row, and the size and shape of slots 64 may vary. Armature 24 is coupled to output member 14. In particular, armature 24 may be coupled to output member 14 by a plurality of leaf springs 66 (best shown in FIG. 1). Springs 66 transmit drive and braking torque from armature 24 to output member 14 and allow for axial movement of armature 24 relative to member 14 and towards and away from rotor disc 36. Springs 66 may be made from stainless steel and are connected at one end to armature 24 and at an opposite end to output member 14 using conventional fasteners 68 such as rivets, screws, bolts, or pins.

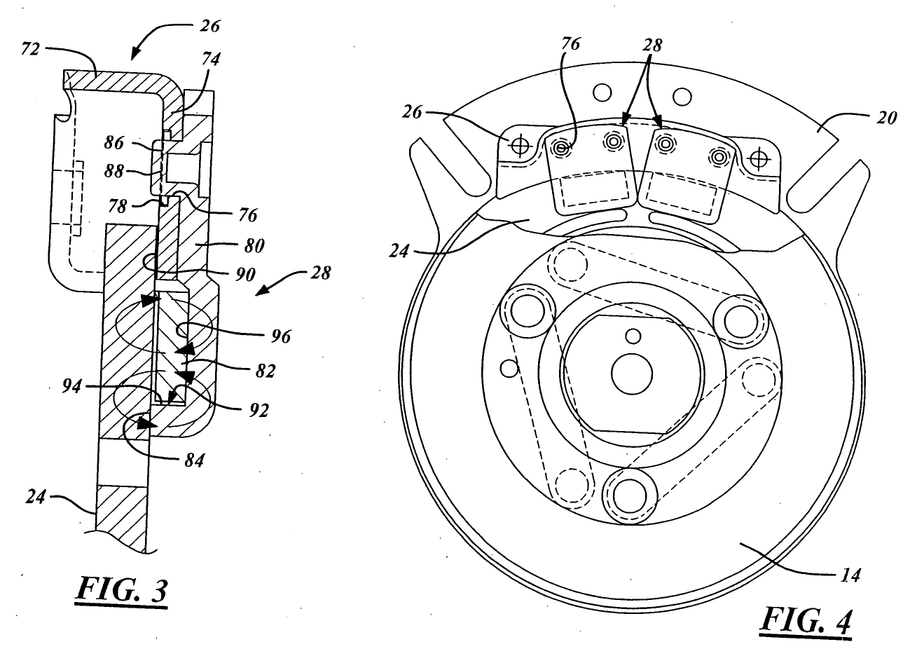

Mounting bracket 26 provides means for mounting one or more brake modules 28. Bracket 26 also provides a means for isolating, and a means limiting and even preventing flux transfer between, (i) the magnetic circuit formed by rotor 18, field shell 20 and armature 24 upon energization of conduction assembly 22 and (ii) the magnetic circuit formed by armature 24 and brake modules 28. Finally, bracket 26 provides a braking surface for armature 24. Bracket 26 may be made from a material having a relatively high magnetic reluctance (including non-magnetic materials) or at least having a higher magnetic reluctance than the materials forming armature 24 and brake modules 28. Bracket 26 may be made from stainless steel or brass. Referring to FIG. 1, bracket 26 may extend about an arcuate portion of device 10 and may be coupled to flange 56 of shell 20 at either arcuate end using conventional fasteners 70. Referring to FIG. 3, bracket 26 is substantially L-shaped in cross-section intermediate its ends with an axially extending leg 72 disposed radially outwardly of armature 24 and a radially inwardly extending leg 74 that is axially aligned with a portion of armature 24 on a side of armature 24 opposite rotor 18. As illustrated, the radially innermost portion of leg 74 of bracket 26 may be axially aligned with the radially outermost portion of armature 24. Leg 74 defines a plurality of apertures 76 and apertures 78 for use in mounting brake modules 28 as described hereinbelow. Apertures 76, 78 extend inwardly from opposite axial sides of leg 74 and open into one another with apertures 78 having a larger diameter than apertures 76. Referring again to FIG. 1, leg 74 defines four circumferentially spaced apertures 76 and apertures 78 in the illustrated embodiment. It should be understood, however, that the size of bracket 26 and the number of apertures 76, 78 may be varied to accommodate variations in brake torque requirements.

Brake modules 28 provide a means for drawing armature 24 away from rotor 18 and braking armature 24 (and, consequently, output member 14). The use of brake modules 28 coupled to mounting bracket 26 enables device 10 to be used in a variety of applications having varying brake torque requirements. In particular, brake modules 28 can be added or removed depending on the brake torque requirements of the application. The brake modules 28 are appropriately positioned and mounted to bracket 26 depending on the number of modules 28 in use. Referring to FIG. 1, for example, in a case where only one brake module 28 is used, the module 28 may be coupled to bracket 26 through the two center apertures 76, 78 to center module 28. Referring to FIG. 4, in a case where two brake modules 28 are used, each module 28 may be coupled to bracket 26 using two adjacent apertures 76, 78. It should be understood that the number of modules 28 and their size and shape, could be varied (along with the size and shape of bracket 26) in accordance with the present invention to further increase or decrease the range of braking torque available. Referring again to FIG. 3, each module 28 may include a brake pole 80 and a permanent magnet 82.

Brake pole 80 provides a braking surface 84 for engagement by armature 24 to brake output member 14. Pole 80 further forms part of a magnetic circuit with armature 24 and magnet 82 and may provide a means for housing magnet 82. Brake pole 80 may be made from conventional materials having a relatively low magnetic reluctance including conventional metals and metal alloys such as steel. Referring to FIG. 1, brake pole 80 extends about at least a portion of the circumference of device 10 and is coupled to bracket 26. Referring again to FIG. 3, pole 80 may define a pair of connectors 86 projecting from one side of pole 80 and configured to extend through apertures 76 in bracket 26. During assembly, a tool may be used to deform each connector 86 such that a head 88 is formed (shown in dotted line in FIG. 3) having a diameter greater than the diameter of aperture 76 and sized to be received within the larger diameter aperture 78 thereby securing pole 80 to bracket 26. Pole 80 is suspended from bracket 26, extending radially inwardly beyond the radially innermost point of bracket 26. Pole 80 is configured such that a portion of pole 80 is radially aligned with bracket 26 and disposed radially inwardly of bracket 26. In particular, braking surface 84 of pole 80 is radially aligned with a corresponding braking surface 90 of bracket 26. Surface 84 is also axially aligned with a portion of armature 24 for engagement with armature 24 during braking. Pole 80 may define a pocket 92 configured to receive magnet 82. In particular, pole 80 may define a pocket 92 formed by a bottom wall 94 disposed on a radially inner side of magnet 82, a side wall 96 disposed on one axial side of magnet 82 opposite armature 24 and, referring to FIG. 1, side walls 98, 100 disposed on either circumferential side of magnet 82. Walls 94, 96, 98, 100 form part of a magnetic circuit between armature 24, magnet 82 and brake pole 80.

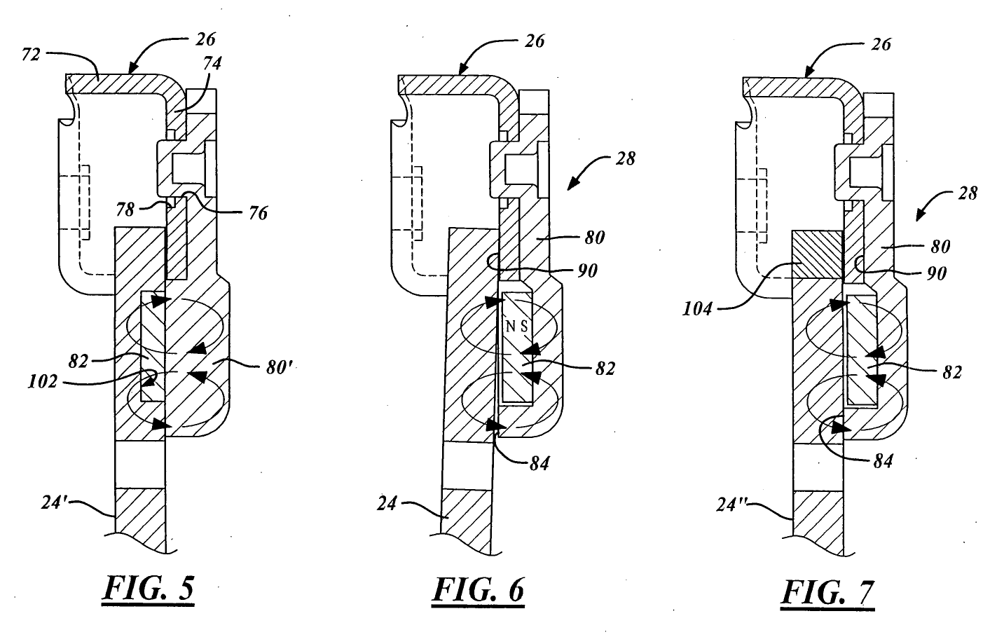

Magnet 82 is provided to create a magnetic circuit between brake pole 80 and armature 24 to draw armature 24 into engagement with brake pole 80 and provide a braking torque to output member 14. Magnet 82 may comprise a neodymium iron boron (Nd—Fe—B) magnet or other known permanent magnet. Magnet 82 is axially aligned with a portion of armature 24 thereby reducing the number of air gaps in the magnetic circuit relative to conventional coupling devices and improving magnetic efficiency, as described in greater detail in commonly assigned, copending U.S. patent application Ser. No. 11/150,027, the entire disclosure of which is incorporated herein by reference. Magnet 82 is oriented such that magnetic flux travels from magnet 82 to armature 24, then from armature 24 to bottom wall 94 and side walls 98, 100 of brake pole 80, from walls 94, 98, 100 into wall 96 of brake pole 80 and from wall 96 of brake pole 80 back to magnet 82. It should be understood, however, that magnet 82 could be oriented in a number of ways to create different flux paths without departing from the spirit of the present invention. As noted above, magnet 82 may be received within a pocket 92 formed in brake pole 80. Referring to FIG. 5, in an alternative embodiment of the invention, magnet 82 may instead be received within a pocket 102 formed in an armature 24′ and axially aligned with a brake pole 80′. Magnet 82 may be arranged such that one face of the magnet 82 is flush with one side (and the braking surface) of brake pole 80 (or armature 24′). By placing magnet 82 such that one face is flush with the braking surface of brake pole 80 (or armature 24′), magnet 82 add to the wear surface of brake pole 80 increasing its wear resistance and the braking surface.

A coupling device in accordance with the present invention is advantageous relative to conventional rotational coupling devices. The use of mounting bracket 26 to mount brake modules 28 enables the use of varying numbers of brake modules 28 thereby allowing relatively easy variation of the device to meet varying brake torque requirements. Bracket 26 also isolates the magnetic circuit created by armature 24, brake pole 80 and magnet 82 (i.e., the braking circuit) from the magnetic circuit created by rotor 18, field shell 20 and armature 24 upon energization of conductor 58 (i.e., the clutch circuit). In particular, because bracket 26 has a higher magnetic reluctance relative to armature 24 and brake pole 80, magnetic flux does not pass from armature 24 and brake pole 80 into field shell 20.

Finally, brake release and clutch engagement is rendered more efficient in the inventive device because the portion of armature 24 engaging bracket 26 is the last part of armature 24 to disengage and the inventive structure therefore breaks the magnetic circuit for the brake more quickly. Referring to FIG. 6, when conductor 58 is energized, armature 24 is drawn away from brake pole 80 and magnet 82 towards rotor 18. Because magnet 82 is aligned with only an arcuate portion of armature 24, the portion of armature 24 diametrically opposite magnet 82 is attracted towards rotor 18 first and skews armature 24 relative to its normal rotational axis 30. This action creates an air gap relative to braking surface 84 of brake pole 80 while armature 24 remains in contact with the braking surface 90 of bracket 26 which is disposed radially outwardly of surface 84. Because braking surface 90 does not form part of the magnetic circuit, however, the attractive force at surface 90 is negligible and armature 24 is released more quickly than in conventional devices. Surface 90 may be coated with, or bracket 26 may be formed from, a material having a relatively low coefficient of friction to hasten release. Referring to FIG. 7, in an alternative embodiment, an armature 24″ may include a ring 104 of material having a magnetic reluctance than is higher than the magnetic reluctance for the rest of armature 24″ and brake pole 80. Ring 104 may be disposed at the radially outer periphery of armature 24″ and is axially aligned with surface 90 of bracket 26. The ring 104 of high reluctance material may be used as an alternative to, or in addition to, the high reluctance material used for bracket 26.

While the invention has been shown and described with reference to one or more particular embodiments thereof, it will be understood by those of skill in the art that various changes and modifications can be made without departing from the spirit and scope of the invention.

We claim:

1. A rotational coupling device, comprising:
a rotor coupled to an input shaft for rotation therewith, said input shaft disposed about a rotational axis;
a field shell disposed about said input shaft and fixed against rotation;
an electrical conductor disposed within said field shell on a first side of said rotor;
an armature disposed about said axis on a second side of said rotor opposite said conductor, said armature coupled to an output member;
a mounting bracket coupled to said field shell a first brake pole coupled to said mounting bracket, said brake pole defining a first braking surface axially aligned with a first portion of said armature on a side of said armature opposite said rotor; and,
a first permanent magnet coupled to one of said first brake pole and said armature and axially aligned with the other of said first brake pole and said armature.

2. The rotational coupling device of claim 1, further comprising:
a second brake pole coupled to said mounting bracket, said second brake pole defining a second braking surface axially aligned with a second portion of said armature on a side of said armature opposite said rotor; and,
a second permanent magnet coupled to one of said second brake pole and said armature and axially aligned with the other of said second brake pole and said armature.

3. The rotational coupling device of claim 1 wherein said first brake pole defines a first connector extending from said first brake pole through a first aperture in said mounting bracket, a head of said first connector having a diameter greater than a diameter of said first aperture.

4. The rotational coupling device of claim 3, wherein said first brake pole defines a second connector extending from said first brake pole through a second aperture in said mounting bracket, a head of said second connector having a diameter greater than a diameter of said second aperture.

5. The rotational coupling device of claim 1 wherein said one of said first brake pole and said armature defines a pocket configured to receive said first permanent magnet.

6. The rotational coupling device of claim 5 wherein said one of said first brake pole and said armature is said first brake pole and said pocket is defined by a first wall disposed on a first axial side of said first permanent magnet opposite said armature, a second wall disposed on a radially inner side of said first permanent magnet and third and fourth walls disposed on either circumferential side of said first permanent magnet, said first, second, third and fourth walls forming part of a magnetic circuit between said armature, said first permanent magnet and said first brake pole.

7. The rotational coupling device of claim 1 wherein a magnetic reluctance of said mounting bracket is greater than a magnetic reluctance of said first brake pole.

8. The rotational coupling device of claim 1 wherein said mounting bracket and said first brake pole include radially aligned braking surfaces configured for selective engagement with said armature.

9. The rotational coupling device of claim 1 wherein said mounting bracket is axially aligned with a second portion of said armature, said second portion of said armature disposed radially outward of said first portion of said armature, and at least one of said mounting bracket and said second portion of said armature has a magnetic reluctance greater than a magnetic reluctance of said first brake pole and said first portion of said armature.

10. The rotational coupling device of claim 9 wherein said second portion of said armature comprises a radially outermost portion of said armature and a radially innermost portion of said mounting bracket is axially aligned with said second portion of said armature.

11. The rotational coupling device of claim 9 wherein said at least one of said mounting bracket and said second portion of said armature is said second portion of said armature and said second portion of said armature forms at least part of a ring extending circumferentially around said armature.

12. The rotational coupling device of claim 9, further comprising:
a second brake pole coupled to said mounting bracket, said second brake pole defining a second braking surface axially aligned with a third portion of said armature on a side of said armature opposite said rotor; and,
a second permanent magnet coupled to one of said second brake pole and said armature and axially aligned with the other of said second brake pole and said armature.

13. The rotational coupling device of claim 9 wherein said first brake pole defines a first connector extending from said first brake pole through a first aperture in said mounting bracket, a head of said first connector having a diameter greater than a diameter of said first aperture.

14. The rotational coupling device of claim 9, wherein said first brake pole defines a second connector extending from said first brake pole through a second aperture in said mounting bracket, a head of said second connector having a diameter greater than a diameter of said second aperture.

15. The rotational coupling device of claim 9 wherein said one of said first brake pole and said armature defines a pocket configured to receive said first permanent magnet.

16. The rotational coupling device of claim 15 wherein said one of said first brake pole and said armature is said first brake pole and said pocket is defined by a first wall disposed on a first axial side of said first permanent magnet opposite said armature, a second wall disposed on a radially inner side of said first permanent magnet and third and fourth walls disposed on either circumferential side of said first permanent magnet, said first, second, third and fourth walls forming part of a magnetic circuit between said armature, said first permanent magnet and said first brake pole.

17. The rotational coupling device of claim 1 wherein a magnetic reluctance of said mounting bracket is greater than a magnetic reluctance of said first brake pole.

18. The rotational coupling device of claim 1 wherein said mounting bracket and said first brake pole include radially aligned braking surfaces configured for selective engagement with said armature.
